(19) United States
(12) Patent Application Publication
(10) Pub. No.: US 2015/0350749 A1
(43) Pub. Date: Dec. 3, 2015

(54) Acute Care Display System

(71) Applicant: David Andrew PYBUS, HAYMARKET NSW (AU)

(72) Inventor: David Andrew PYBUS, HAYMARKET NSW (AU)

(21) Appl. No.: 14/290,998

(22) Filed: May 30, 2014

(51) Int. Cl. H04Q 9/00; G06F 3/0482; G06F 3/0484; G06F 3/0481

(52) U.S. Cl. CPC H04Q 9/00; G06F 3/04817; G06F 3/0482; G06F 3/04847; H04Q 2209/40; H04Q 2209/50

(57) ABSTRACT

A data integration and display system; the system capturing and integrating digital output data from a plurality of disparate physiological monitoring equipment monitoring the physiological states of a patient; the digital output data configured for display on a single graphical display screen as icons.

### TECHNICAL FIELD

The present invention relates to the monitoring of the vital functions of a patient and, more particularly, to the monitoring of these functions of a patient under intensive care or anaesthesia.

### BACKGROUND

Physiological monitors which are currently in use incorporate sensitive audio alarm systems which can be set for each of the monitored variables, but tend to generate a large number of false alarms. (In some studies, false alarm conditions outnumber true alarm conditions by a ratio of more than nine to one.)

A paradoxical secondary effect of the high false alarm rate of modern monitoring systems is that the response times to true alarm states tend to be prolonged (presumably because the carer is encouraged to believe that an alarm condition is most likely to be false). Clearly, such performance failures markedly reduce the utility of modern monitoring systems.

Although various server-based, near real-time computer systems are available for the transmission of anaesthetic monitor data to “smart” phones, such as that of Airstrip Technologies (http://www.airstriptech.com), these are expensive and typically render the data in a traditional “XY” or simple alphanumeric format.

The present invention addresses some of these problems. Physiological data are transmitted directly (and wirelessly) from the patient monitor to a ‘Smartphone’ or personal computer and then displayed in real time using either a conventional XY display or by means of various novel, dynamic display icons. Once the data are captured by the ‘SmartPhone’, subsets of the data can also then be transmitted to either a ‘SmartWatch’ or ‘Head-Up Display and again displayed in an iconic format.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### SUMMARY OF INVENTION

Accordingly, in a first preferred form of the invention, there is provided a data integration and display system; the system capturing and integrating digital output data from a plurality of disparate physiological monitoring equipments monitoring the physiological states of a patient; the digital output data configured for display on a single graphical display screen as icons.

Preferably, the physiological monitoring equipments include monitors of circulation, oxygenation, ventilation and anaesthetic states of the patient.

Preferably, the graphical display screen represents each of the physiological states by icons color-coded to represent predefined ranges of the physiological states.

Preferably, the display comprises four icons respectively representative of the circulation, oxygenation, ventilation and anaesthetic states.

Preferably, the icons are presented as an array of discs.

Preferably, the color of the icons switches between green, yellow and red; each color corresponding to a predefined range of amplitude values generated by the respective monitoring equipment.

Preferably, the icons comprise a dynamic display of the physiological states as monitored by the respective monitoring equipments; the display including a bar representing values between zero and an upper limit for Systole, BIS and End-tidal C0₂.

Preferably, the bar is a vertical bar.

Preferably, an extent of a portion of the vertical bar displaying a color switchable between green, yellow and red, represents an instantaneous amplitude value of C0₂; the colors green, yellow and red representing ranges of fresh gas composition.

Preferably, a first level indicator is moveable along the vertical bar; position of the indicator along the vertical bar indicative of systolic pressure.

Preferably, the level indicator switches between display and non display of a color of the first level indicator; the rate of switching indicative of a pulse rate of a patient.

Preferably, the first level indicator comprises a pair of opposing arrow heads located on either side of the vertical bar.

Preferably, a second level indicator is movable along the vertical bar; the second level indicator switchable in color between green, yellow and red; position of the second level indicator indicative of the level of BIS score; the color of the second level indicator indicative of BIS range.

Preferably, the second level indicator comprises a disc moving within the vertical bar.

Preferably, a central one fifth portion of the vertical bar is displayed in a frame; the frame providing a reference for preferred levels of each of the indicators associated with the vertical bar.

Preferably, n the icons are included in the display of a smart watch.

Preferably, the icons are projected onto a lens of a pair of smart glasses.

Preferably, the physiological monitoring equipment(s) are adapted to transmit amplitude data to a digital input/output device.

Preferably, the digital input/output device is a smart phone.

Preferably, software implemented on the digital input/output device processes received amplitude data for output as a graphical display.

Preferably, graphical display data prepared by the digital input/output device is displayed on a display screen of the digital input/output device.

Preferably, graphical display data prepared by the digital input/output device is transmitted for display on a display screen of a smart watch.

Preferably, graphical display data prepared by the digital input/output device is projected for display on a lens of a pair of smart spectacles.

In another broad form of the invention, there is provided a method of monitoring physiological states of a patient; the method including
processing digital output data from a plurality of monitoring equipments,
configuring the digital output data for display on a single display screen as icons.

Preferably, the digital output data comprises amplitude values generated by the monitoring equipments transmitted to a digital input/output device via Bluetooth or WiFi.

Preferably, the digital input/output device is a smart phone.

Preferably, software implemented on the digital input/output device processes received amplitude values into a graphical display for display on the single display screen.

Preferably, the single display screen is a screen of the smart phone.

Preferably, the single display screen is a screen of a smart watch.

Preferably, the single display screen is a lens of a pair of smart spectacles.

Preferably, the graphical display comprises an array of icons; the icons switchable in color between green, yellow and red; each color indicative of a range of the amplitude values of respective physiological states.

Preferably, the graphical display includes a vertical bar and first and second level indicators; a portion and color of the portion of the bar and positions of the first and second level indicators representative of respective physiological states.

### BRIEF DESCRIPTION OF DRAWINGS

Embodiments of the present invention will now be described with reference to the accompanying drawings wherein:

FIG. 1 is a schematic of an acute care data acquisition and display system according to preferred embodiments of the invention,

FIG. 2 is an enlarged view of a first preferred embodiment of icons of the system of FIG. 1 displayed on a wearable device,

FIG. 3 is an enlarged view of a dynamic icon arrangement according to a further preferred embodiment of the system of FIG. 1,

FIG. 4 is an enlarged view of the dynamic icons of FIG. 3 projected onto another wearable device.

### DESCRIPTIONS OF EMBODIMENTS

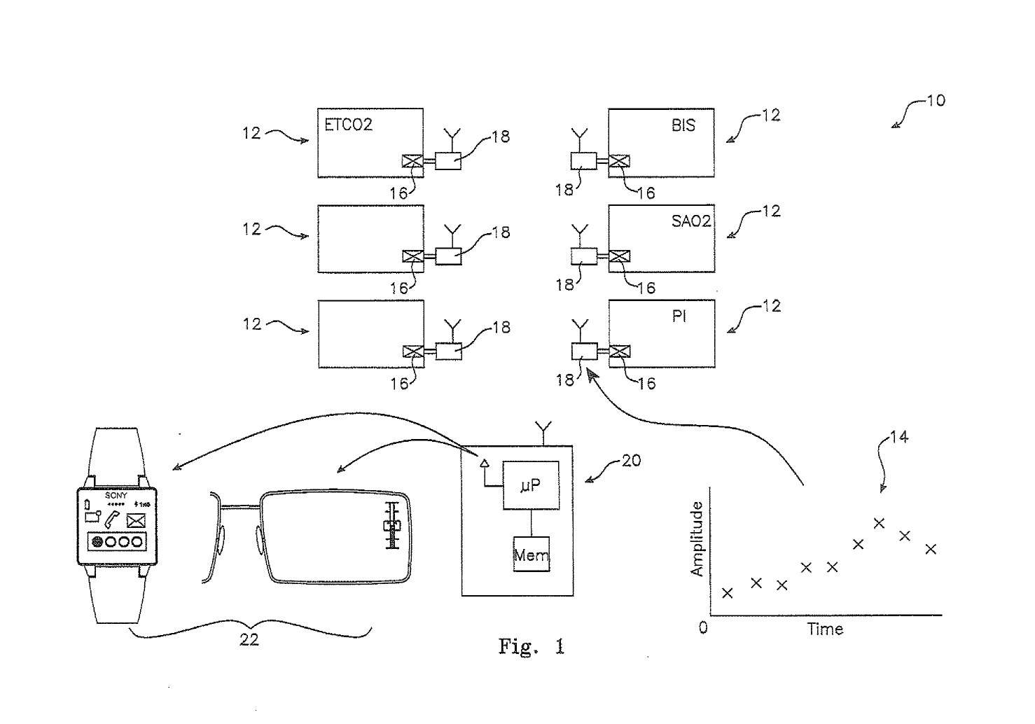

With reference to FIG. 1, a data integration and display system 10 captures and integrates digital output data from a plurality of disparate physiological monitoring equipments 12 which monitor various physiological states of a patient (not shown), and configures this digital output data for display on a single graphical display screen(s).

The physiological monitoring equipments 12 include at least monitors of the circulation, oxygenation, ventilation and the anaesthetic state of the patient.

The captured digital data includes amplitude data 14 generated by the monitoring devices 12. These data can be extracted for processing on, or recording by, other devices via RS232 serial ports 16. In the present invention, digital output data is transmitted, either via Bluetooth or WiFi from each monitoring equipment by means of wireless RS232 Serial Adaptors 18.

The transmitted data are received by a digital input/output device equipped with Bluetooth and/or WiFi capability, located within range of the Serial Adaptors 18. In a preferred embodiment of the invention, the receiving digital input/output device is a Smart Phone 20, for example a Samsung Galaxy S4 running under the Android operating system.

Unlike existing systems, complete monitor dataset(s) are received by the device. Subsets of the data can the be used to populate graphical or alphanumeric displays, supply the input data for use by real-time “Expert Alarm Systems” running on the device itself, or create and update audio-visual data display “icons”.

In contrast, the devices used by existing systems simply function as “browsing” devices. Virtually no processing of the physiological data displayed by these “browsers” is possible and the data are not available for real-time analysis by the device itself.

Software implemented on the Smart Phone 20, processes the received amplitude values 14 and outputs the data in the form of a graphical display 22. This graphical display can be received via Bluetooth or WiFi to a wearable “smart” device such as those illustrated in FIG. 1. Alternatively, or as well, the generated graphical display 22 may be viewed on the screen of the Smart Phone 20 itself.

### First Preferred Embodiment

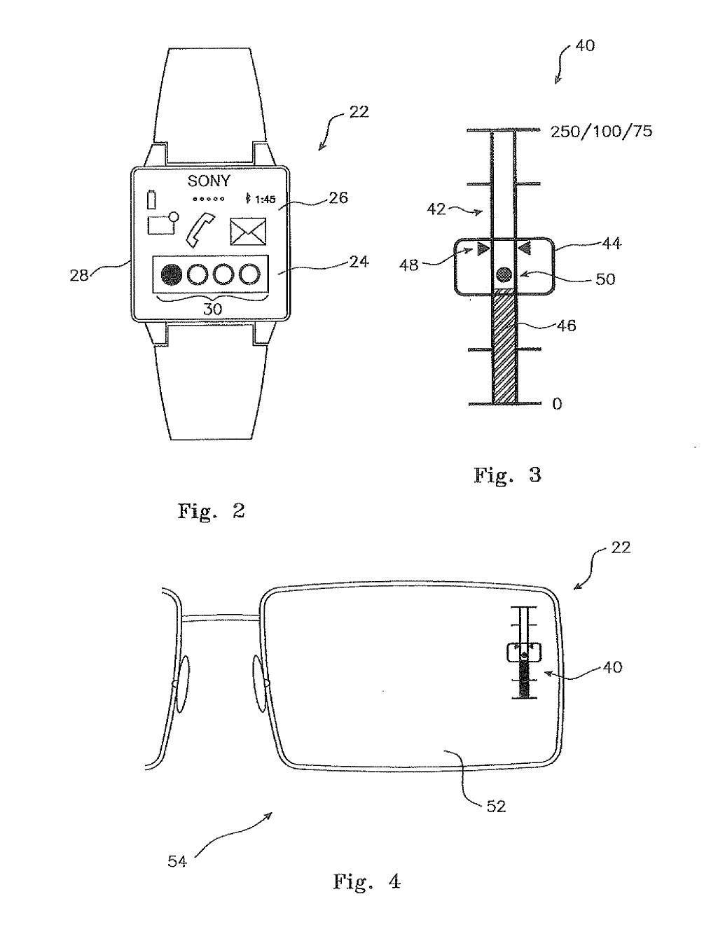

With reference now to FIG. 2, in a first preferred embodiment of the invention, the graphical display 22 is comprises an array 24 of four icons 30 in the form of discs arranged, in this example, side by side on the screen 26 of a smart watch 28, such as the Sony “SmartWatch”.

The graphical display 22 represents each of the monitored physiological states by the icons 30, color coded to represent predefined ranges of the physiological states. Preferably, the colors of the icons 30 switch between green, yellow and red with each color corresponding to a predefined range of amplitude values 14 generated by the respective monitoring equipments 12.

The letters “C”, “O”, “V” and “A” (representing the physiological domains of “Circulation”, “Oxygenation”, “Ventilation” and depth of “Anaesthesia”) can also, optionally, be displayed on the icons.

The graphical display 22 represents each of the monitored physiological states by the icons 30, color coded to represent predefined ranges of the physiological states.

Preferably, the colors of the icons 30 switch between green, yellow and red with each color corresponding to a predefined range of amplitude values 14 generated by the respective monitoring equipment 12. Alternatively, the icons colors may be switched according to the dictates of an ‘Expert Alarm System’ which analyses the state of the data in the four physiological domains and categorises each of the four states as “Acceptable” (Green), “Marginally Abnormal” (Yellow) or “Hazardous” (Red).

If running on a “SmartWatch”, a “Hazardous” condition can also be signalled to user by activating the vibration function of the watch.

### Second Preferred Embodiment

With reference now to FIG. 4, color coded icons in this second embodiment, comprise a dynamic display 40, again representing the physiological states of a patient as monitored by the respective monitoring equipment 12 of FIG. 1.

The display 40 includes a preferably vertical bar 42 representing values between zero and an upper limit for each of Systole (250), BIS (100) and End-tidal C0₂ (75). Preferably the length of the vertical bar 42 is divided into five equal sections with middle fifth section highlighted by a frame or window 44.

A variable colored portion 46 of the vertical bar 42 extending upward from zero, represents an instantaneous amplitude value of C0₂ within the range of zero to 75 mm Hg. The color of portion 44 is switchable between green, yellow and red, with the colors green, yellow and red representing ranges of fresh gas composition.

The color green is displayed if the patient's SaO2 is greater than 95% and the fractional concentration of oxygen in the inspired gas greater than 0.21.

The color yellow is displayed if the patient's SaO2 is in the range 90-95% and the fractional concentration of oxygen in the inspired gas less than 0.95.

The color red is displayed if the patient's SaO2 is less than 90% and the fractional concentration of oxygen in the inspired gas less than 0.95.

The display 40 further includes a first level indicator 48, comprising a pair of arrow heads arranged at opposite sides of the vertical bar 42. First level indicator 48 is moveable along the vertical bar, with its position indicative of systolic blood pressure within the range of zero to 250 mm Hg.

The opposing pair of arrow heads of first level indicator 48 switch in color between green, yellow and red, indicating ranges of saturation (Green >95%, Yellow 90-95%, Red <90%). Furthermore, the displayed color switches or pulses between display and non display at a rate equal to the pulse rate of a patient.

A second level indicator 50 is also movable along the vertical bar 42. Again, this second level indicator 50 is switchable in color between green, yellow and red to indicate ranges of BIS (Green <60%, Yellow 60-80%, Red >80%). The position of the second level indicator 50 along the vertical bar 42 is indicative of the BIS score between zero and 100.

The frame or window 44 indicates a preferred region of the vertical bar 42 in which the various physiological indicators are at, or near optimum, and provides a rapid reference to an observer of any indicator moving into a range of concern.

The user is also able to adjust the position of this frame so as to redefine the optimal range for the displayed values.

### INDUSTRIAL APPLICABILITY

The present invention provides for rapid and convenient monitoring of the critical physiological parameters of a patient under intensive care of anaesthetic, without the need for constant reference to the more complex displays of each piece of monitoring equipment 12. As shown in FIGS. 1, 2 and 4, the dynamic icons of the graphic display of either the first or second preferred embodiments described above and generated by the input/output device, may be displayed on a wearable device.

Either the array of colored discs or the more complex arrangement of the icons of FIG. 3, may be transmitted to a smart watch 28, or as shown in FIG. 4, may be projected onto the lens 52 of a pair of “smart” spectacles 54. As noted above, in addition to or alternatively, the icon displays can also be displayed on the screen of the smart phone input/output device. A further advantage of the present invention is that the icon displays may be shown on any suitable Bluetooth and/or WiFi enabled device which is within range of the input/output device 20 so that more than one observer may be alerted to significant changes in the status of a vital physiological signals.

1. A data integration and display system; the system capturing and integrating digital output data from a plurality of disparate physiological monitoring equipments monitoring the physiological states of a patient; the digital output data configured for display on a single graphical display screen as icons.

2. The system of claim 1 wherein the physiological monitoring equipments include monitors of circulation, oxygenation, ventilation and anaesthetic states of the patient.

3. The system of claim 1 wherein the graphical display screen represents each of the physiological states by icons color-coded to represent predefined ranges of the physiological states.

4. The system of claim 3 wherein the display comprises four icons respectively representative of the circulation, oxygenation, ventilation and anaesthetic states.

5. The system of claim 3 wherein the icons are presented as an array of discs.

6. The system of claim 3 wherein the color of the icons switches between green, yellow and red; each color corresponding to a predefined range of amplitude values generated by the respective monitoring equipment.

7. The system of claim 3 wherein the icons comprise a dynamic display of the physiological states as monitored by the respective monitoring equipments; the display including a bar representing values between zero and an upper limit for Systole, BIS and End-tidal C0₂.

8. The system of claim 7 wherein the bar is a vertical bar.

9. The system of claim 7 wherein an extent of a portion of the vertical bar displaying a color switchable between green, yellow and red, represents an instantaneous amplitude value of C0₂; the colors green, yellow and red representing ranges of fresh gas composition.

10. The system of claim 7 wherein a first level indicator is moveable along the vertical bar; position of the indicator along the vertical bar indicative of systolic pressure.

11. The system of claim 7 wherein the level indicator switches between display and non display of a color of the first level indicator; the rate of switching indicative of a pulse rate of a patient.

12. The system of claim 11 wherein the first level indicator comprises a pair of opposing arrow heads located on either side of the vertical bar.

13. The system of claim 7 wherein a second level indicator is movable along the vertical bar; the second level indicator switchable in color between green, yellow and red; position of the second level indicator indicative of the level of BIS score; the color of the second level indicator indicative of BIS range.

14. The system of claim 13 wherein the second level indicator comprises a disc moving within the vertical bar.

15. The system of claim 7 wherein a central one fifth portion of the vertical bar is displayed in a frame; the frame providing a reference for preferred levels of each of the indicators associated with the vertical bar.

16. The system of claim 4 wherein the icons are included in the display of a smart watch.

17. The system of claim 4 wherein the icons are projected onto a lens of a pair of smart glasses.

18. The system of claim 1 wherein the physiological monitoring equipment(s) are adapted to transmit amplitude data to a digital input/output device.

19. The system of claim 18 wherein the digital input/output device is a smart phone.

20. The system of claim 18 wherein software implemented on the digital input/output device processes received amplitude data for output as a graphical display.

21. The system of claim 20 wherein graphical display data prepared by the digital input/output device is displayed on a display screen of the digital input/output device.

22. The system of claim 20 wherein graphical display data prepared by the digital input/output device is transmitted for display on a display screen of a smart watch.

23. The system of claim 20 wherein graphical display data prepared by the digital input/output device is projected for display on a lens of a pair of smart spectacles.

24. A method of monitoring physiological states of a patient; the method including
processing digital output data from a plurality of monitoring equipments,
configuring the digital output data for display on a single display screen as icons.

25. The method of claim 24 wherein the digital output data comprises amplitude values generated by the monitoring equipments transmitted to a digital input/output device via Bluetooth or WiFi.

26. The method of claim 25 wherein the digital input/output device is a smart phone.

27. The method of claim 24 wherein software implemented on the digital input/output device processes received amplitude values into a graphical display for display on the single display screen.

28. The method of claim 27 wherein the single display screen is a screen of the smart phone.

29. The method of claim 27 wherein the single display screen is a screen of a smart watch.

30. The method of claim 27 wherein the single display screen is a lens of a pair of smart spectacles.

31. The method of claim 24 wherein the graphical display comprises an array of icons; the icons switchable in color between green, yellow and red; each color indicative of a range of the amplitude values of respective physiological states.

32. The method of claim 24 wherein the graphical display includes a vertical bar and first and second level indicators; a portion and color of the portion of the bar and positions of the first and second level indicators representative of respective physiological states.
